(19) United States
(12) Patent Application Publication
(10) Pub. No.: US 2023/0246349 A1
(43) Pub. Date: Aug. 3, 2023

(54) ELECTRICAL CONTINUITY COAXIAL CABLE CONNECTOR

(71) Applicant: EZCONN CORPORATION, New Taipei City (TW)

(72) Inventor: Chi Bin HUANG, New Taipei City (TW)

(21) Appl. No.: 18/155,248

(22) Filed: Jan. 17, 2023

(30) Foreign Application Priority Data
Jan. 21, 2022 (TW) 111200864

(51) Int. Cl. H01R 9/05; H01R 24/40

(52) U.S. Cl. CPC H01R 9/0521; H01R 24/40

(57) ABSTRACT

A cable connector engages with an external thread surface of an electronic device, including a torque sleeve and a post. The torque sleeve includes a first end and an internal thread formed on the first end. The post is coaxially arranged in the torque sleeve, and the post includes a head portion and a body portion, where the head portion directly contacts the external thread surface of the device. When the torque sleeve gradually moves from a first position to a second position relative to the external thread surface of the device, one end of the external thread of the device abuts the head portion of the post, allowing the post to move axially. Having the head portion of the post in contact with the external thread surface, the cable connector is able to generate electrical conduction even if not completely fastened, which provides a continuous electrical conduction effect.

### CROSS REFERENCE TO RELATED APPLICATION

This application claims priority to Taiwan (TW) Application No. 111200864 filed on Jan. 21, 2022, which is incorporated herein by reference in its entirety.

### FIELD

The present invention is related to a connector for coupling cable to the terminal, especially, related to a coaxial cable connector, wherein the coaxial cable connector is installed easily without special compression tools and has good electrical continuity.

### BACKGROUND

In addition to being used in cable television signal reception, coaxial cable connectors are also commonly used in the field of broadband communications. As shown in FIG. 1, the conventional coaxial cable connector 9 includes a post 91, an outer sleeve 92, a nut 93, and a compression sleeve 94. A front end 921 of the outer sleeve 92 is in contact with the outer peripheral surface of the post 91, and a rear end 922 of the outer sleeve 92 cooperates with the post 91 to define a space 923 for a coaxial cable 8 to partially penetrate. The nut 93 is rotatably fixed on the post 91 and the outer sleeve 92. The rear end 922 of the outer sleeve 92 is compressed toward the post 91 by a professional compression tool (not shown in the figure) to prevent the coaxial cable 8 from detaching.

When the conventional coaxial cable connector 9 is combined with an external port 71 of an electronic device 7, an internal thread 931 of the nut 93 is connected to an external thread surface 711 of the external port 71. By tightening the nut 93, the center conductor 81 of the coaxial cable 8 is electrically connected and coupled with the center channel 712 of the external port 71, thereby realizing the electrical and mechanical connection between the electronic device 7 and the coaxial cable connector 9.

The conventional coaxial cable connector 9 often suffers from poor electrical ground contact in use. The reason is that the nut 93 will loosen over time so that the nut 93 fails to fully contact the post 91. For example, the nut 93 may not be properly tightened initially due to an improper number of rotations, or there may be a gap caused by pulling. In addition, the conventional coaxial cable connector 9 may not be properly fastened to the external port 71 of the electronic device 7 due to tolerances, which may cause intermittent problems of poor electrical continuity, which leads to other external signals have the opportunity to enter through the coaxial cable connector 9. Therefore, a related improvement method is to add an elastic conductive element 95 between the nut 93, the post 91 and the external port 71 of the electronic device 7, so that such elements can be in close contact with each other. However, even if various elastic conductive elements 95 with different structures are added, the nut 93 and the external port 71 of the electronic device 7 must be screwed together to a certain extent before electrical conduction, that is, the conventional coaxial cable connector 9 is initially incapable of electrical conduction. When other external signals pass through, unnecessary electrical interference may affect the quality of signal transmission.

Furthermore, the conventional coaxial cable connectors 9 must use the special professional compression tools, which is not convenient, intuitive, and efficient for ordinary users to use, and the users must purchase the special professional compression tools at an additional cost.

Accordingly, a coaxial cable connector is provided.

### SUMMARY

The purpose of the present invention is to provide a coaxial cable connector that can solve at least one of the disadvantages of the conventional coaxial cable connector.

The purpose of the present invention is to provide a coaxial cable connector that can be installed easily without special compression tools and has good electrical continuity.

The present invention provides a coaxial cable connector. The coaxial cable connector is suitable for engaging with an external thread surface of an electronic device. The coaxial cable connector includes a torque sleeve, and a post. The torque sleeve includes a first end and an internal thread formed on the first end. The post is coaxially arranged in the torque sleeve, and the post includes a head portion and a body portion, wherein the coaxial cable connector is connected to the electronic device, the head portion is used to connect directly to the external thread surface of the electronic device. When the torque sleeve gradually moves from a first position to a second position relative to the external thread surface of the electronic device, one end of the external thread of the electronic device abuts the head portion of the post, allowing the post to move axially relative to the torque sleeve.

In some embodiments, the inner diameter of the head portion of the post is larger than the inner diameter of the body portion.

In some embodiments, an inner diameter of the head portion of the post is tapered toward the first end of the torque sleeve.

In some embodiments, the inner diameter of the head portion of the post is wavy-shaped in the radial direction.

In some embodiments, the head portion of the post has a surrounding wall and a plurality of slots formed in the surrounding wall.

In some embodiments, the slots extend axially from an open end.

In some embodiments, the head portion of the post has a surrounding wall and a slot formed in the surrounding wall, the slot communicates with opposite sides of the surrounding wall to form a C-shaped head portion on the post.

In some embodiments, the head portion of the post further has a plurality of axially extending hollows, the hollows are formed in the surrounding wall and are closed without communicating with opposite sides of the surrounding wall.

In some embodiments, the head portion of the post further has a plurality of ribs, the ribs are connected to the inner peripheral surface of the surrounding wall and are in direct contact with the external thread surface of the electronic device.

In some embodiments, the head portion of the post further has a plurality of elastic portions, the elastic portions are bent and extended from one side of the surrounding wall toward the inside, and the elastic portions are configured to directly contact the external thread surface of the electronic device.

In some embodiments, the torque sleeve further includes a first extension portion connected to the first end and a stop portion protruding inward from the inner surface of the first extension portion, when the torque sleeve is in the second position, the head portion of the post abuts against the stop portion of the torque sleeve.

In some embodiments, the head portion of the post has a notch that accommodates the stop portion of the torque sleeve.

In some embodiments, the coaxial cable connector further includes an end sleeve, wherein the torque sleeve further includes a second end connected to the first end, the end sleeve is sleeved on the second end of the torque sleeve, the end sleeve includes a stop portion extending toward the first end of the torque sleeve, when the torque sleeve is in the second position, the head portion of the post abuts against the stop portion of the end sleeve.

In some embodiments, the coaxial cable connector further comprises an end sleeve, wherein the torque sleeve further has a second end opposite to the first end and a second extension portion connected to the second end, the post further includes a tail portion connected to the body portion, the end sleeve is coaxially arranged in the second end of the torque sleeve, when the torque sleeve is in the second position, the radial distance between the tail portion of the post and the end sleeve is smaller than the radial distance between the body portion of the post and the second extension portion of the torque sleeve.

In some embodiments, the inner surface of the end sleeve has an inner groove.

In some embodiments, the inner surface of the end sleeve is stepladder-like, the end sleeve includes a first annular surface and a second annular surface, the inner diameter of the first annular surface is larger than the inner diameter of the second annular surface.

In some embodiments, the end sleeve further includes a first engagement portion formed on the outer surface, the first engagement portion is fitted into a second engagement portion on the inner surface of the second end of the torque sleeve to prevent the end sleeve from moving in the axial direction.

In some embodiments, the length of the torque sleeve in the axial direction is longer than the overall length of the post.

The present invention also provides a coaxial cable connector. The coaxial cable connector is suitable for engaging with an external thread surface of an electronic device. The coaxial cable connector includes a torque sleeve, and a post. The torque sleeve includes a first end and an internal thread formed on the first end. The post is coaxially arranged in the torque sleeve and includes a head portion and a body portion, wherein the head portion surrounds and directly contacts the external thread surface of the electronic device, the torque sleeve moves relative to the external thread surface of the electronic device between a first position and a second position. When the torque sleeve is in the first position, a first distance is defined in the axial direction between the first end of the torque sleeve and the head portion of the post. When the torque sleeve is in the second position, a second distance is defined in the axial direction between the first end of the torque sleeve and the head portion of the post, the second distance is larger than the first distance.

In some embodiments, the head portion of the post is an electrical conductor, when the coaxial cable connector is not completely installed on the external thread surface of the electronic device, the head portion of the post and the external thread surface of the electronic device are in contact with each other and are electrically connected.

In some embodiments, the head portion of the post is pushed by the inner peripheral surface of the torque sleeve and comes into close contact with the external thread surface of the electronic device as the torque sleeve gradually moves from the first position to the second position.

In some embodiments, the torque sleeve further includes an annular torsion portion formed on the outer peripheral surface, which enables the user to rotate the torque sleeve rotating relative to the external thread surface by applying force.

The present invention also provides a coaxial cable connector. The coaxial cable connector is suitable for engaging with an external thread surface of an electronic device. The coaxial cable connector includes a torque sleeve, and a post. The torque sleeve includes a first end and a second end oppositely arranged, and an internal thread formed on the first end. The post is coaxially arranged in the torque sleeve. The post includes a head portion and a tail portion oppositely arranged, wherein the head portion is used to connect directly to the external thread surface of the electronic device, wherein the head portion of the post is confined within the torque sleeve, and the torque sleeve is movable between a first position and a second position. When the torque sleeve is in the first position, the tail portion of the post is not surrounded by the second end of the torque sleeve. When the torque sleeve is in the second position, the tail portion of the post is surrounded by the second end of the torque sleeve.

In some embodiments, the torque sleeve further includes a second extension portion between the first end and the second end, the inner diameter of the second end of the torque sleeve is smaller than the inner diameter of the second extension portion, when the torque sleeve is in the first position, the second end of the torque sleeve defines a surrounding space for a coaxial cable to pass through, when the torque sleeve is in the second position, the tail portion of the post penetrates into the surrounding space, resulting in a smaller surrounding space.

The present invention also provides a coaxial cable connector. The coaxial cable connector includes a torque sleeve and a post. The torque sleeve includes an annular torsion portion formed on the outer peripheral surface thereof, and an internal thread formed the inner peripheral surface and located at one end. The post is coaxially arranged in the torque sleeve. The post is freely moved axially relative to the torque sleeve and is provided with an elastic element.

In some embodiments, the torque sleeve further includes a rough portion formed on the outer peripheral surface of the torque sleeve and spaced from the annular torsion portion.

### BRIEF DESCRIPTION OF THE DRAWINGS

Unless specified otherwise, the accompanying drawings illustrate aspects of the innovative subject matter described herein. Referring to the drawings, wherein like reference numerals indicate similar parts throughout the several views, several examples of coaxial cable connector incorporating aspects of the presently disclosed principles are illustrated by way of example, and not by way of limitation.

FIG. 1 illustrates a cross-sectional perspective view of a traditional coaxial cable connector for coupling a coaxial cable.

FIG. 2 illustrates an exploded perspective view of a first embodiment of a coaxial cable connector of the present invention.

FIG. 3 illustrates a cross-sectional perspective view of the first embodiment in a first position, which is not completely combined with an external thread surface of an electronic device.

FIG. 4 illustrates a cross-sectional perspective view of the first embodiment in a second position, which is completely combined with the external thread surface of the electronic device.

FIG. 5 illustrates a front-side view of a first variation example of a post of the first embodiment.

FIG. 6 illustrates a stereogram view of a second variation example of the post of the first embodiment.

FIG. 7 illustrates a stereogram view of a third variation example of the post of the first embodiment.

FIG. 8 illustrates a front-side view of a fourth variation example of the post of the first embodiment.

FIG. 9 illustrates a cross-sectional perspective view of a first variation example of an end sleeve of the first embodiment.

FIG. 10 illustrates a cross-sectional perspective view of a second variation example of the end sleeve of the first embodiment.

FIG. 11 illustrates a cross-sectional perspective view of a third variation example of the end sleeve of the first embodiment.

FIG. 12 illustrates a cross-sectional perspective view of a second embodiment in a first position of a coaxial cable connector of the present invention.

FIG. 13 illustrates a cross-sectional perspective view of the second embodiment in a second position.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings but are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

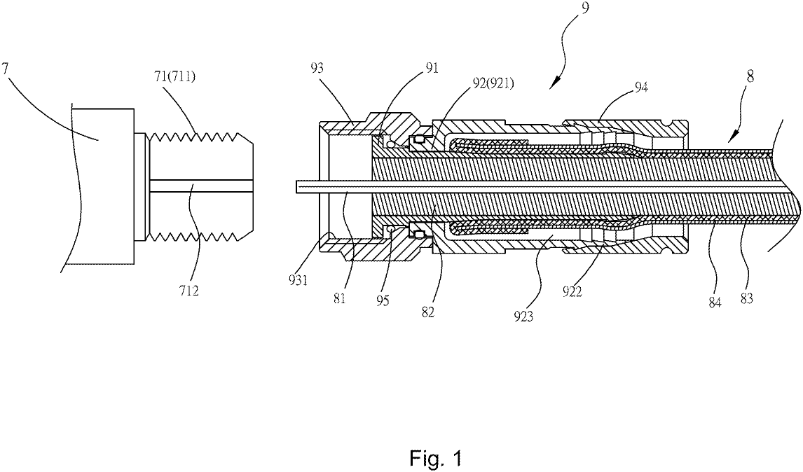

As shown in FIG. 1, the coaxial cable 8 includes a center conductor 81, an insulating layer 82, a shielding layer (not shown), a braided layer 83, and a plastic jacket 84 sequentially from the inside to the outside. The material of the center conductor 81 includes copper, iron, silver, nickel, gold, copper-gold alloy, copper-tin alloy, copper-nickel alloy or other polymer, non-metallic conductors with good conductivity and so on. The braided layer 83 includes a metal layer containing aluminum, a metal layer containing copper and a conductive layer containing conductive materials, such as an aluminum foil coating layer or a copper foil coating layer. The braided layer 83 is electrical shielded so that the interference effect can be decreased. The form of the braided layer 83 includes different covering forms such as two-layer weaving (Standard), three-layer weaving (Tri-shield) and four-layer weaving (Quad).

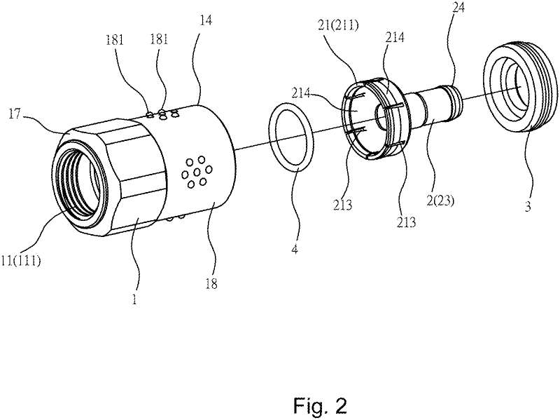

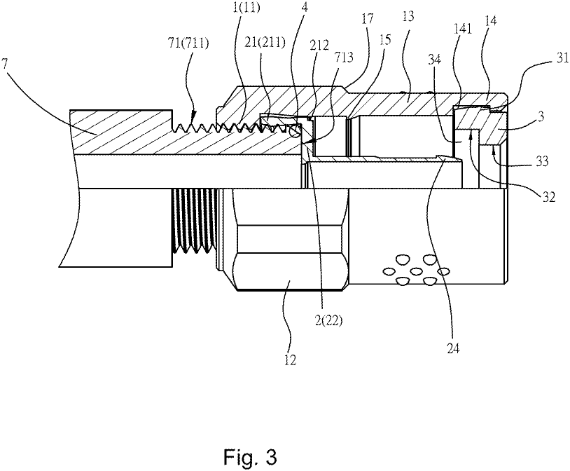

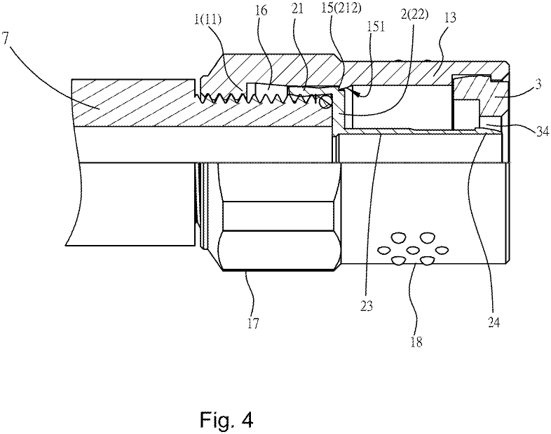

FIG. 2 illustrates an exploded perspective view of a first embodiment of a coaxial cable connector of the present invention. FIG. 3 illustrates a cross-sectional perspective view of the first embodiment in a partially attached position, which is not completely combined with an external thread surface of an electronic device. FIG. 4 illustrates a cross-sectional perspective view of the first embodiment in a fully engaged position, which is completely combined with the external thread surface of the electronic device. Referring to FIGS. 2 to 4, the present invention provides a coaxial cable connector that is suitable for mounting on an external port 71 of an electronic device 7 (as shown in FIG. 3). The external port 71 includes an axially extending external thread surface 711 and a radially extending end surface 713. The coaxial cable connector includes a torque sleeve 1, a post 2, an end sleeve 3, and a sealing element 4. The torque sleeve 1, the post 2, and the end sleeve 3 are arranged in a coaxial manner to receive the coaxial cable. The material of the post 2 can be one of metal materials such as copper, iron, silver, nickel, gold, copper-gold alloy, copper-tin alloy, copper-nickel alloy, or a combination. The material of the torque sleeve 1 and end sleeve 3 can be non-metal (such as plastic) or metal as required.

The torque sleeve 1 includes a first end 11, a first extension portion 12, a second extension portion 13, and a second end 14 which are connected in sequence. Preferably, the torque sleeve 1 further includes an annular torsion portion 17 forming on the outer peripheral surface thereof, and a rough portion 18 spaced apart from the annular torsion portion 17. The inner diameter of the first end 11 is smaller than the inner diameter of the first extension portion 12, and an internal thread 111 is formed on the inner surface of the first end 11. A stop portion 15 protrudes inwardly from the inner surface of the first extension portion 12. The stop portion 15 cooperates with the first end 11 to define an accommodating space 16 in the axial direction. In this embodiment, the length of the torque sleeve 1 in the axial direction is longer than the overall length of the post 2, and a second engagement portion 141 is formed on the inner surface of the second end 14 of the torque sleeve 1. The rough portion 18 may also be specially designed with multiple micro-dimples, micro-bumps, or notches in different patterns, etc., to enhance the user’s grip feeling. In this embodiment, the rough portion 18 of the torque sleeve 1 has a plurality of visible protruding particles 181, which increases the friction force and makes it easier for user to hold. In the radial direction, the outer diameter of the annular torsion portion 17 of the torque sleeve 1 is larger than the outer diameter of the rough portion 18, and the appearance of the annular torsion portion 17 can be any shape, such as hexagonal, square, or annular. In some embodiments, the torque sleeve 1 may have an outer peripheral surface with a smooth surface next to the annular torsion portion 17 instead of a rough surface.

The post 2 has an integral molding design and is arranged inside the torque sleeve 1. The post 2 includes a head portion 21, a neck portion 22, a body portion 23 and a tail portion 24 that are connected to each other. The inner diameter of the head portion 21 is larger than the inner diameter of the body portion 23 and the inner diameter of the tail portion 24. The head portion 21 is a conductor and is used for direct contact with the external thread surface 711 of the electronic device 7. The neck portion 22 is used to abut against the end surface 713 of the external port 71 of the electronic device 7.

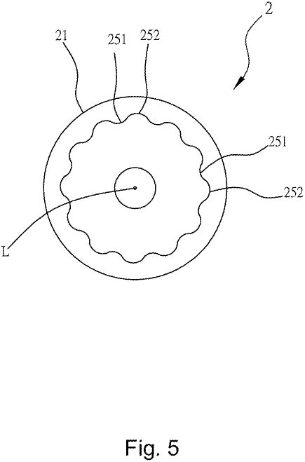

In this embodiment, the head portion 21 of the post 2 is confined within the accommodating space 16 of the torque sleeve 1. The head portion 21 of the post 2 has a surrounding wall 211, a notch 212, and a plurality of slots 213. The notch 212 is used for accommodating the stop portion 15 of the torque sleeve 1. The slots 213 are formed in the surrounding wall 211 and all extend axially from an open end toward the neck portion 22, so that the head portion 21 forms a plurality of elastic pieces 214 spaced apart from each other on the circumference. Preferably, the inner diameter of the head portion 21 is tapered toward the first end 11 of the torque sleeve 1 in the axial direction as viewed from the cross-section. In some embodiments, the inner diameter may also be uniformly extended axially to fit on the external thread surface 711 of the external port 71. As long as the head portion 21 directly contacts the external thread surface 711 of the external port 71 in use, for example, the inner diameter of the head portion 21 of the post 2 may also be a wavy in the radial direction, as shown in FIG. 5. That is, the inner surface of the head portion 21 has a plurality of convex portions 251 protruding toward the axis L and a plurality of concave portions 252 receding away from the axis L, as seen from the circumferential side, the convex portion 251 and the concave portion 252 are staggered. The surface of each convex portion 251 facing the axis L could be arc-shaped and used to directly contact the external thread surface 711 of the external port 71. Any change to the inner diameter of the head portion 21 that directly contacts the external thread surface 711 of the external port 71 is included in the scope of application of the present invention. In addition, the head portion 21 of the post 2 may also be one single piece extending outward from the neck portion 22, and is designed to not completely surround the external thread surface 711 of the external port 71, for example, the radian of the head portion 21 of the post 2 around the external port 71 is less than 180 degrees, or, there is only one slot 213 connecting the opposite sides of the surrounding wall 211, so that the head portion 21 of the post 2 is C-shaped, and the radian of the head portion 21 around the external port 71 is greater than 180 degrees.

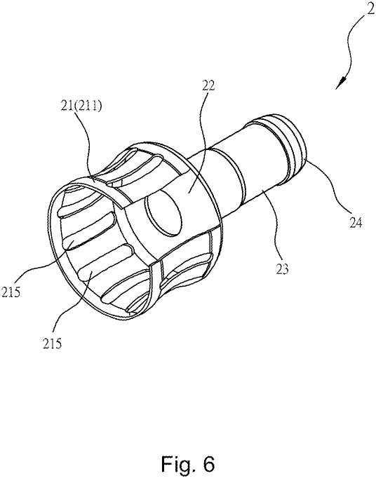

FIG. 6 illustrates a stereogram view of a second variation example of the post of the first embodiment. Referring to FIG. 6, in some embodiments, additionally to being C-shaped, the head portion 21 of the post 2 further has a plurality of axially extending hollows 215 formed in the surrounding wall 211, which are closed without communicating with opposite sides of the surrounding wall 211.

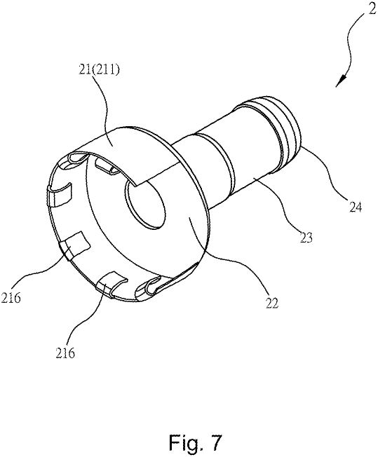

FIG. 7 illustrates a stereogram view of a third variation example of the post of the first embodiment. Referring to FIG. 7, in some embodiments, the head portion 21 of the post 2 also has a plurality of elastic portions 216. The elastic portions 216 are all bent and extended from one side of the surrounding wall 211 toward the inside of the surrounding wall 211. The elastic portions 216 are used for directly connecting with the external thread surface 711 of the electronic device 7. By compressing the elastic portions 216, the elastic portions 216 of the post 2 come into close contact with the external thread surface 711 of the electronic device 7 when the head portion 21 of the post 2 is pushed by the inner peripheral surface of the torque sleeve 1.

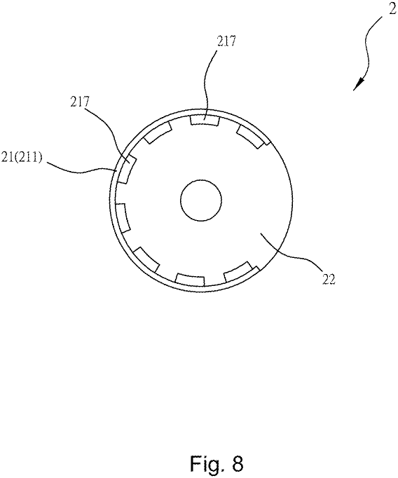

FIG. 8 illustrates a front-side view of a fourth variation example of the post of the first embodiment. Referring to FIG. 8, in some embodiments, the head portion 21 of the post 2 further has a plurality of ribs 217, the ribs 217 are connected to the inner peripheral surface of the surrounding wall 211 and extend axially, and the ribs 217 are used to directly contact with the external thread surface 711 of the electronic device 7. As shown above in some exemplary examples, the head portion 21 of the post 2 of the coaxial cable connector of the present invention can be designed with elastic elements of various shapes and appearances to be electrically connected to the external thread surface 711 of the electronic device 7.

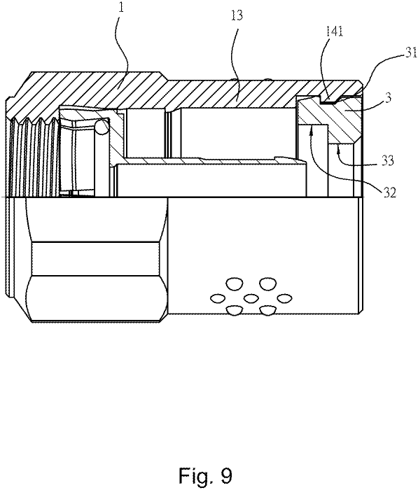

Referring to FIGS. 2 to 4, the end sleeve 3 is arranged around the second end 14 of the torque sleeve 1. The end sleeve 3 includes a first engagement portion 31 formed on the outer surface thereof, the first engagement portion 31 is able to be fitted into the second engagement portion 141 of the torque sleeve 1, which prevents the end sleeve 3 from moving linearly relative to the torque sleeve 1. In this embodiment, the shape of the first engagement portion 31 of the end sleeve 3 and the second engagement portion 141 of the torque sleeve 1 is that the convex part and the concave part are matched, but some embodiments may adopt the opposite design. That is, the first engagement portion 31 of the end sleeve 3 is a concave, whereas the second engagement portion 141 of the torque sleeve 1 is a convex (as shown in FIG. 9). Additionally, the end sleeve 3 has a stepladder-like inner surface, as well as a first annular surface 32 and a second annular surface 33, wherein the inner diameter of the first annular surface 32 is greater than that of the second annular surface 33. The inner diameter of the second extension portion 13 of the torque sleeve 1 is larger than the inner diameter of the first annular surface 32 of the end sleeve 3.

Referring to FIGS. 2 to 4, the procedure of assembling the coaxial cable connector of the present invention, for example, involves firstly installing the head portion 21 of the post 2 inside the torque sleeve 1 from the second end 14 of the torque sleeve 1 to the first end 11, wherein the head portion 21 of the post 2 becomes slightly compressed and deformed when passing through a guiding bevel 151 of the stop portion 15, returns to its original shape after completely passing through the stop portion 15, and is restricted in the accommodating space 16 of the torque sleeve 1; next, plug the first engagement portion 31 of the end sleeve 3 into the second engagement portion 141 of the second end 14 of the torque sleeve 1, and finally, the sealing element 4 is inserted into the head portion 21 of the post 2 from the first end 11 of the torque sleeve 1, thus completing the assembly.

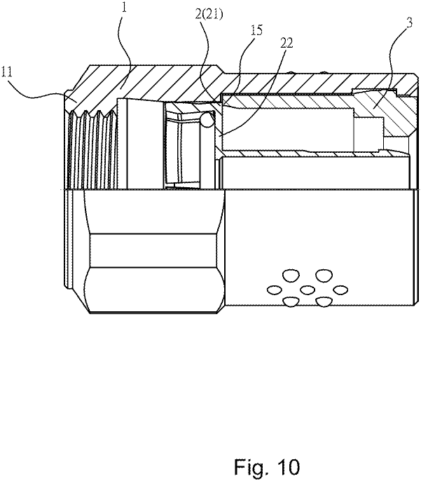

After the coaxial cable connector of the present invention has been assembled, the torque sleeve 1 can be moved between a partially attached position (as shown in FIG. 3) and a fully engaged position (as shown in FIG. 4) relative to the post 2. In the partially attached position, the first end 11 of the torque sleeve 1 and the head portion 21 of the post 2 cooperate to define a first distance in the axial direction, and the end sleeve 3, at the second end 14 of the torque sleeve 1, defines a surrounding space 34 where the coaxial cable can pass. The first distance is the minimum value when the head portion 21 of the post 2 is very close to the first end 11 of the torque sleeve 1 in the axial direction, while the tail portion 24 of the post 2 does not surround the second end 14 of the torque sleeve 1. In the fully engaged position, a second distance exists axially between the head portion 21 of the post 2 and the first end 11 of the torque sleeve 1 when the notch 212 of the head portion 21 of the post 2 abuts against the stop portion 15 of the torque sleeve 1, the second distance is greater than the first distance. The radial distance between the tail portion 24 of the post 2 and the end sleeve 3 is smaller than the radial distance between the body portion 23 of the post 2 and the second extension portion 13 of the torque sleeve 1. In some embodiments, the stop portion 15 may not be formed on the inner surface of the torque sleeve 1, but at the end position of the end sleeve 3 (as shown in FIG. 10). The end sleeve 3 includes a stop portion 15 extending toward the first end 11 of the sleeve 1. When the torque sleeve 1 is in the fully engaged position, the head portion 21 of the post 2 abuts on the stop portion 15 of the end sleeve 3. Additionally, the head portion 21 of the post 2 can also be designed without a notch 212, but directly abuts against the stop portion 15 flush with the neck portion 22.

Referring to FIGS. 2 to 4, the advantages of the present invention are described below through the steps of installing the coaxial cable connector on the external port 71 of the electronic device 7:

It should be noted that the coaxial cable is omitted in FIGS. 3 and 4, and the related structure of the coaxial cable can be viewed in FIG. 1. First, install the coaxial cable in the coaxial cable connector of the present invention, wherein the center conductor of the coaxial cable to pass through the body portion 23 and the head portion 21 of the post 2 to the center channel in the external port 71. The body portion 23 of the post 2 accommodates the coaxial cable’s center conductor, insulating layer and shielding layer. The body portion 23 of the post 2 and the torque sleeve 1 together surround a space that accommodates the braided layer and the plastic jacket of the coaxial cable.

Next, the coaxial cable connector of the present invention is initially connected to the external port 71 of the electronic device 7. When the neck portion 22 of the post 2 abuts against the end surface 713 of the external port 71, the head portion 21 of the post 2 is in direct contact with the external thread surface 711 of the external port 71. Even though the coaxial cable connector of the present invention is partially installed on the external thread surface 711 of the electronic device 7, the head portion 21 of the post 2 and the external thread surface 711 of the electronic device 7 have already been touched, so the conduction effect of electrical connection can be established at the beginning of the process. Furthermore, the coaxial cable connector of the present invention does not add any other conductive elements between the post 2 and the external thread surface 711 of the electronic device 7, so there is no increase in resistance to affect the electrical conduction.

Finally, rotate the torque sleeve 1 such that the internal thread 111 gradually moves from the partially attached position to the fully engaged position relative to the external thread surface 711 of the electronic device 7. By gradually moving away from the first end 11 of the torque sleeve 1, the head portion 21 of the post 2 is pushed by one end of the external thread of the external port 71 until it abuts against the stop portion 15 of the torque sleeve 1. By gradually embedding the tail portion 24 of the post 2 into the surrounding space 34 defined by the end sleeve 3, the surrounding space 34 is reduced to compress the coaxial cable, preventing the coaxial cable from being detached from the coaxial cable connector of the present invention. The user can install the coaxial cable connector on the external port 71 of the electronic device 7 without using special compression tools. The torque sleeve 1 has not only the internal thread 111 on its inner surface, but also the annular torsion portion 17 on its outer peripheral surface, which provide a large area of contact with the user’s fingers. The torque sleeve 1 is rotated by the user by applying force to the annular torsion portion 17. By rotating the torque sleeve 1 relative to the external thread surface 711 of the external port 71, the end surface 713 of the external thread abuts the head portion 21 of the post 2, thereby allowing the post 2 to move axially.

Additionally, when the torque sleeve 1 and the post 2 are moved relative to each other, the head portion 21 of the post 2 is pushed by the inner peripheral surface of the torque sleeve 1 and contacts the external thread surface 711 of the electronic device 7 in a tighter fit. The coaxial cable connector of the present invention and the external port 71 of the electronic device 7 can continuously provide the effect of electrical conduction from the beginning to the end of the installation process. The head portion 21 of the post 2 has been substantially mounted to the external port 71. Once the torque sleeve 1 has gradually moved to the fully engaged position, the tail portion 24 of the post 2 and the second end 14 of the torque sleeve 1 are matched to clamp the coaxial cable. In some embodiments, the torque sleeve 1 may not have the stop portion 15, for example, set the post 2 to the torque sleeve 1 when the outer diameter of the head portion 21 of the post 2 is close to the inner diameter of the first extension portion 12 of the torque sleeve 1. As long as there is not sufficient external force is applied, the torque sleeve 1 cannot freely move axially relative to the post 2 in the natural state. Because there is a frictional force between the contact surface of the head portion 21 of the post 2 and the first extension portion 12 of the torque sleeve 1. Therefore, even without the structural design of the stop portion 15, the torque sleeve 1 can still function similarly. The torque sleeve 1 or the end sleeve 3 having a stop portion 15 offers the advantage of preventing excessive axial displacement of the torque sleeve 1 relative to the post 2.

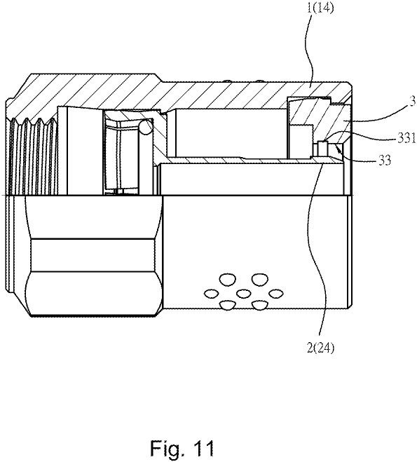

FIG. 11 illustrates a cross-sectional perspective view of a third variation example of the end sleeve of the first embodiment. Referring to FIG. 11, in some embodiments, the inner surface of the end sleeve 3 has an inner groove 331, the inner groove 331 is formed on the second annular surface 33 and the inner surface of the end sleeve 3 is stepladder-like. The inner groove 331 is used to accommodate the part of the coaxial cable that is squeezed and deformed, so that the coaxial cable clamped between the end sleeve 3 and the post 2 has a better tensile strength. Regardless of whether the inner surface of the end sleeve has a uniform inner diameter or a stepladder-like one, if the end sleeve is designed with an inner groove, the end sleeve can accommodate a partially squeezed and deformed coaxial cable, achieving the same purpose and effect.

The advantages of the coaxial cable connector of the present invention can be summarized as follows:

(1) The coaxial cable connector of the present invention and the electronic device maintain electrical continuity through the head portion of the post in direct contact with the external thread surface of the external port, during any process of initial installation or complete installation. It provides appropriate shielding to prevent noise and other forms of telecommunication interference, ensuring signal transmission quality.

(2) Unlike traditional coaxial cable connectors, the coaxial cable connector of the present invention does not require a professional compression tool. By rotating the torque sleeve and moving relative to the post, the surrounding space for accommodating the coaxial cable can be reduced, effectively preventing the coaxial cable from detaching.

(3) The torque sleeve has a greater axial length than the post’s overall length, and the annular torsion portion offers the user with a larger contact area to perform rotations more conveniently.

(4) Components of the coaxial cable connector of the present invention are small in number, compact and simple in structure, and can reduce costs effectively.

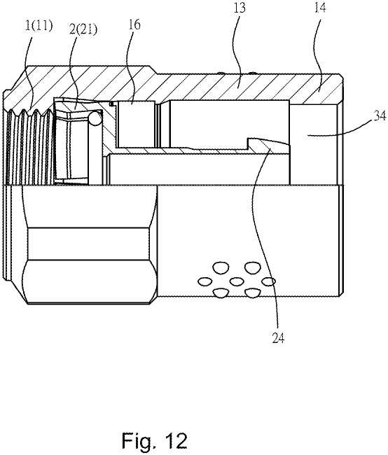

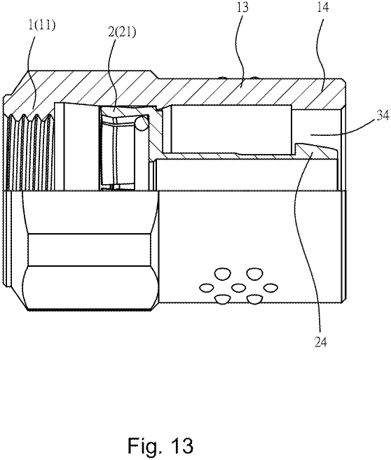

FIG. 12 illustrates a cross-sectional perspective view of a second embodiment in a partially attached position of a coaxial cable connector of the present invention. FIG. 13 illustrates a cross-sectional perspective view of the second embodiment in a fully engaged position. Referring to FIGS. 12 to 13, the second embodiment of the coaxial cable connector of the present invention is similar to the first embodiment, with the following main differences:

The second end 14 of the torque sleeve 1 is not provided with an end sleeve. The inner diameter of the torque sleeve 1 at the second end 14 is smaller than the inner diameter of the second extension portion 13, and the tail portion 24 of the post 2 has an obvious hook portion protruding from its outer surface. The head portion 21 of the post 2 is confined within the accommodating space 16 of the torque sleeve 1, and the torque sleeve 1 is movable between a partially attached position and a fully engaged position relative to the post 2. In the partially attached position (as shown in FIG. 12), the tail portion 24 of the post 2 and the second end 14 of the torque sleeve 1 do not surround each other, and the second end 14 of the torque sleeve 1 defines a surrounding space 34 for the coaxial cable to pass through. In the fully engaged position (as shown in FIG. 13), the tail portion 24 of the post 2 penetrates the surrounding space 34 to make the surrounding space 34 smaller. The tail portion 24 of the post 2 and the second end 14 of the torque sleeve 1 are concentrically surrounded by each other.

Thus, the second embodiment can also achieve the same effect and purpose as the first embodiment.

In summary, the coaxial cable connector of the present invention is designed to directly contact the external thread surface of the external port through the head portion of the post, so that the coaxial cable connector of the present invention can generate electrical conduction and has continuous electrical conduction effects during use. In addition, the coaxial cable connector of the present invention can prevent the coaxial cable from being separated without the use of special compression tools, thereby achieving the purpose of the present invention.

The presently disclosed inventive concepts are not intended to be limited to the embodiments shown herein, but are to be accorded their full scope consistent with the principles underlying the disclosed concepts herein. Directions and references to an element, such as “up,” “down,”, “upper,” “lower,” “horizontal,” “vertical,” “left,” “right,” and the like, do not imply absolute relationships, positions, and/or orientations. Terms of an element, such as “first” and “second” are not literal, but, distinguishing terms. As used herein, terms “comprises” or “comprising” encompass the notions of “including” and “having” and specify the presence of elements, operations, and/or groups or combinations thereof and do not imply preclusion of the presence or addition of one or more other elements, operations and/or groups or combinations thereof. Sequence of operations do not imply absoluteness unless specifically so stated. Reference to an element in the singular, such as by use of the article “a” or “an”, is not intended to mean “one and only one” unless specifically so stated, but rather “one or more”. As used herein, “and/or” means “and” or “or”, as well as “and” and “or.” As used herein, ranges and subranges mean all ranges including whole and/or fractional values therein and language which defines or modifies ranges and subranges, such as “at least,” “greater than,” “less than,” “no more than,” and the like, mean subranges and/or an upper or lower limit. All structural and functional equivalents to the elements of the various embodiments described throughout the disclosure that are known or later come to be known to those of ordinary skill in the relevant art are intended to be encompassed by the features described and claimed herein. Moreover, nothing disclosed herein is intended to be dedicated to the public regardless of whether such disclosure may ultimately explicitly be recited in the claims. No element or concept disclosed herein or hereafter presented shall be construed under the provisions of 35 USC 112(f) unless the element or concept is expressly recited using the phrase “means for” or “step for”.

In view of the many possible embodiments to which the disclosed principles can be applied, we reserve the right to claim any and all combinations of features and acts described herein, including the right to claim all that comes within the scope and spirit of the foregoing description, as well as the combinations recited, literally and equivalently, in the following claims and any claims presented anytime throughout prosecution of this application or any application claiming benefit of or priority from this application.

What is claimed is:

1. A coaxial cable connector, suitable for engaging with an external thread surface of an electronic device, the coaxial cable connector comprising:
a torque sleeve, including a first end and an internal thread formed on the first end; and
a post, coaxially arranged in the torque sleeve, including a head portion and a body portion, characterized in that the coaxial cable connector is connected to the electronic device, the head portion is used to connect directly to the external thread surface of the electronic device, when the torque sleeve gradually moves from a first position to a second position relative to the external thread surface of the electronic device, one end of the external thread of the electronic device abuts the head portion of the post, allowing the post to move axially.

2. The coaxial cable connector of claim 1, wherein the inner diameter of the head portion of the post is larger than the inner diameter of the body portion.

3. The coaxial cable connector of claim 1, wherein an inner diameter of the head portion of the post is tapered toward the first end of the torque sleeve.

4. The coaxial cable connector of claim 1, wherein the inner diameter of the head portion of the post is wavy-shaped in the radial direction.

5. The coaxial cable connector of claim 1, wherein the head portion of the post has a surrounding wall and a plurality of slots formed in the surrounding wall.

6. The coaxial cable connector of claim 5, wherein the slots extend axially from an open end.

7. The coaxial cable connector of claim 1, wherein the head portion of the post has a surrounding wall and a slot formed in the surrounding wall, the slot communicates with opposite sides of the surrounding wall to form a C-shaped head portion on the post.

8. The coaxial cable connector of claim 7, wherein the head portion of the post further has a plurality of axially extending hollows, the hollows are formed in the surrounding wall and are closed without communicating with opposite sides of the surrounding wall.

9. The coaxial cable connector of claim 7, wherein the head portion of the post further has a plurality of ribs, the ribs are connected to the inner peripheral surface of the surrounding wall and are in direct contact with the external thread surface of the electronic device.

10. The coaxial cable connector of claim 7, wherein the head portion of the post further has a plurality of elastic portions, the elastic portions are bent and extended from one side of the surrounding wall toward the inside, and the elastic portions are configured to directly contact the external thread surface of the electronic device.

11. The coaxial cable connector of claim 1, wherein the torque sleeve further includes a first extension portion connected to the first end and a stop portion protruding inward from the inner surface of the first extension portion, when the torque sleeve is in the second position, the head portion of the post abuts against the stop portion of the torque sleeve.

12. The coaxial cable connector of claim 11, wherein the head portion of the post has a notch that accommodates the stop portion of the torque sleeve.

13. The coaxial cable connector of claim 1, further comprising an end sleeve, wherein the torque sleeve further includes a second end connected to the first end, the end sleeve is sleeved on the second end of the torque sleeve, the end sleeve includes a stop portion extending toward the first end of the torque sleeve, when the torque sleeve is in the second position, the head portion of the post abuts against the stop portion of the end sleeve.

14. The coaxial cable connector of claim 1, further comprising an end sleeve, wherein the torque sleeve further has a second end opposite to the first end and a second extension portion connected to the second end, the post further includes a tail portion connected to the body portion, the end sleeve is coaxially arranged in the second end of the torque sleeve, when the torque sleeve is in the second position, the radial distance between the tail portion of the post and the end sleeve is smaller than the radial distance between the body portion of the post and the second extension portion of the torque sleeve.

15. The coaxial cable connector of claim 14, wherein the inner surface of the end sleeve has an inner groove.

16. The coaxial cable connector of claim 14, wherein the inner surface of the end sleeve is stepladder-like, the end sleeve includes a first annular surface and a second annular surface, the inner diameter of the first annular surface is larger than the inner diameter of the second annular surface.

17. The coaxial cable connector of claim 16, wherein the end sleeve further includes a first engagement portion formed on the outer surface, the first engagement portion is fitted into a second engagement portion on the inner surface of the second end of the torque sleeve to prevent the end sleeve from moving in the axial direction.

18. The coaxial cable connector of claim 1, wherein the length of the torque sleeve in the axial direction is longer than the overall length of the post.

19. A coaxial cable connector, suitable for engaging with an external thread surface of an electronic device, the coaxial cable connector comprising:
a torque sleeve, including a first end and an internal thread formed on the first end; and
a post, coaxially arranged in the torque sleeve, including a head portion and a body portion, wherein the head portion surrounds and directly contacts the external thread surface of the electronic device, the torque sleeve moves relative to the external thread surface of the electronic device between a first position and a second position, when the torque sleeve is in the first position, a first distance is defined in the axial direction between the first end of the torque sleeve and the head portion of the post, when the torque sleeve is in the second position, a second distance is defined in the axial direction between the first end of the torque sleeve and the head portion of the post, the second distance is larger than the first distance.

20. The coaxial cable connector of claim 19, wherein the head portion of the post is an electrical conductor, when the coaxial cable connector is not completely installed on the external thread surface of the electronic device, the head portion of the post and the external thread surface of the electronic device are in contact with each other and are electrically connected.

21. The coaxial cable connector of claim 19, wherein the head portion of the post is pushed by the inner peripheral surface of the torque sleeve and comes into close contact with the external thread surface of the electronic device as the torque sleeve gradually moves from the first position to the second position.

22. The coaxial cable connector of claim 19, wherein the torque sleeve further includes an annular torsion portion formed on the outer peripheral surface, which enables the user to rotate the torque sleeve rotating relative to the external thread surface by applying force.

23. A coaxial cable connector, suitable for engaging with an external thread surface of an electronic device, the coaxial cable connector comprising:
a torque sleeve, including a first end and a second end oppositely arranged, and an internal thread formed on the first end; and
a post, coaxially arranged in the torque sleeve, including a head portion and a tail portion oppositely arranged, wherein the head portion is used to connect directly to the external thread surface of the electronic device, wherein the head portion of the post is confined within the torque sleeve, and the torque sleeve is movable between a first position and a second position, when the torque sleeve is in the first position, the tail portion of the post is not surrounded by the second end of the torque sleeve, when the torque sleeve is in the second position, the tail portion of the post is surrounded by the second end of the torque sleeve.

24. The coaxial cable connector of claim 23, wherein the torque sleeve further includes a second extension portion between the first end and the second end, the inner diameter of the second end of the torque sleeve is smaller than the inner diameter of the second extension portion, when the torque sleeve is in the first position, the second end of the torque sleeve defines a surrounding space for a coaxial cable to pass through, when the torque sleeve is in the second position, the tail portion of the post penetrates into the surrounding space, resulting in a smaller surrounding space.

25. A coaxial cable connector, comprising:
a torque sleeve, including an annular torsion portion formed on the outer peripheral surface thereof, and an internal thread formed the inner peripheral surface and located at one end; and
a post, coaxially arranged in the torque sleeve, being freely moved axially relative to the torque sleeve, being provided with an elastic element.

26. The coaxial cable connector of claim 25, wherein the torque sleeve further includes a rough portion formed on the outer peripheral surface of the torque sleeve and spaced from the annular torsion portion.
